(19) United States
(12) Patent Application Publication
(10) Pub. No.: US 2020/0278817 A1
(43) Pub. Date: Sep. 3, 2020

(54) IMAGE FORMING SYSTEM, IMAGE FORMING APPARATUS, OUTPUT METHOD, AND STORAGE MEDIUM

(71) Applicant: CANON KABUSHIKI KAISHA, Tokyo (JP)

(72) Inventor: Hirokazu Tokumoto, Kashiwa-shi (JP)

(21) Appl. No.: 16/798,740

(22) Filed: Feb. 24, 2020

(30) Foreign Application Priority Data
Mar. 1, 2019 (JP) 2019-037775

(51) Int. Cl. G06F 3/12

(52) U.S. Cl. CPC G06F 3/1204; G06F 3/1288; G06F 3/1261; G06F 3/1207

(57) ABSTRACT

An image forming system comprises a document receiving apparatus, an output apparatus, and a bibliography server. The document receiving apparatus comprises a first processor capable of executing first instructions causing the document receiving apparatus to receive and store print jobs. The bibliography server comprises a second processor capable of executing second instructions causing the bibliography server to receive bibliographic information including a storage location of each print job and store the bibliographic information. The output apparatus comprises a third processor capable of executing third instructions causing the output apparatus to acquire the bibliographic information, display the bibliographic information; and acquire a print job selected from the storage location and execute the print job.

### BACKGROUND OF THE INVENTION

### Field of the Invention

The present disclosure relates to an image forming system, an image forming apparatus, an output method, and a storage medium.

### Description of the Related Art

Conventional multifunction peripherals immediately perform printing upon receiving a print job from a terminal apparatus such as a personal computer (PC). In this case, there is a possibility that an information leak will occur as a result of the printed matter being left behind or a third party seeing the uncollected printed matter. Therefore, in recent years, in order to maintain confidentiality, hold printing has been proposed in which a print job is retained in a nonvolatile storage area, without being printed, upon having been received, and printing is performed thereafter when a print instruction is given from a user through an operation unit of a multifunction peripheral (Japanese Patent Laid-Open No. 2007-251279).

Also, in recent years, remote hold printing has been proposed in which printing can be performed not only by acquiring a print job from a multifunction peripheral that received the print job but also by acquiring a print job from another multifunction peripheral that retains the print job (Japanese Patent Laid-Open No. 2010-211627).

There are cases in which hold printing is used when printing is performed using a multifunction peripheral that is usually used by a user, and remote hold printing is used when printing is performed using a multifunction peripheral that is not usually used by a user, depending on the congestion state of the multifunction peripherals, for example.

However, in conventional technologies, if the above-described hold printing and remote hold printing are dynamically switched in response to an operation made by a user to a multifunction peripheral, in the case of remote hold printing, print jobs need to be acquired from multifunction peripherals that are targets of the remote hold printing, and it takes a long time to display a document list. A mechanism is required that enables the user to display and print printing targets stress-free regardless of which of hold printing and remote hold printing is selected under a circumstance in which both types of printing are supported.

### SUMMARY OF THE INVENTION

The present disclosure was made in view of the above-described conventional examples, and it is one object of the present disclosure to provide a mechanism that makes it possible to display and print printing targets stress-free even if remote hold printing is selected. Also, one object of another aspect of the present disclosure is to enhance the convenience of a hold printing function.

In order to achieve the above-described objects, one aspect of the present invention is an image forming system comprising a document receiving apparatus, an output apparatus, and a bibliography server, the document receiving apparatus comprising: a first memory storing first instructions; and a first processor which is capable of executing the first instructions causing the document receiving apparatus to accept and store print jobs, the bibliography server comprising: a second memory storing second instructions; and a second processor which is capable of executing the second instructions causing the bibliography server to receive bibliographic information that includes a storage location of each print job from the document receiving apparatus and store the bibliographic information, and the output apparatus comprising: a third memory storing third instructions; and a third processor which is capable of executing the third instructions causing the output apparatus to: acquire the bibliographic information from the bibliography server; in response to an instruction for remote hold printing, display the bibliographic information as a list of print jobs that are output targets; and acquire a print job selected from the list, from the storage location and execute the print job.

Another aspect of the present invention is an image forming apparatus configured to function as an output apparatus that is connected to a document receiving apparatus that accepts and stores print jobs and a bibliography server that receives bibliographic information including a storage location of each print job from the document receiving apparatus and stores the bibliographic information, the image forming apparatus comprising: a memory storing instructions; and a processor which is capable of executing the instructions causing the image forming apparatus to: acquire the bibliographic information from the bibliography server; display, in response to an instruction for remote hold printing, the acquired bibliographic information as a list of print jobs that are output targets; and acquire, in response to an instruction, a print job selected from the list, from the storage location and execute the print job.

Further features of the present invention will become apparent from the following description of exemplary embodiments with reference to the attached drawings.

### BRIEF DESCRIPTION OF THE DRAWINGS

FIG. 1 is a diagram showing a network configuration of a remote hold printing system.

FIG. 2 is a block diagram showing a schematic configuration of a multifunction peripheral.

FIG. 3 is a block diagram showing a software configuration of a multifunction peripheral.

FIG. 4 shows one example of icon buttons for hold printing and remote hold printing, which are displayed by a multifunction peripheral.

FIGS. 5A and 5B respectively show one example of a document list screen of hold printing and one example of a document list screen of remote hold printing, which are displayed by a multifunction peripheral.

FIGS. 6A to 6C are block diagrams showing an actual form of bibliographic information stored in an output apparatus.

FIG. 7 is a block diagram showing a saving format of bibliographic information stored in an output apparatus according to Embodiment 1.

FIG. 8 is a flow chart showing one exemplary procedure of processing performed by a document receiving apparatus according to Embodiment 1.

FIG. 9 is a flow chart showing one exemplary procedure of document list display processing performed by the output apparatus according to Embodiment 1.

FIG. 10 is a flow chart showing one exemplary procedure of processing performed by a bibliography server apparatus according to Embodiment 1.

FIG. 11 is a flow chart showing one exemplary procedure of printing performed by the output apparatus according to Embodiment 1.

FIG. 12 is a flow chart showing one exemplary procedure of print data transmission performed by the document receiving apparatus according to Embodiment 1.

FIG. 13 is a block diagram showing a saving format of bibliographic information stored in an output apparatus according to Embodiment 2.

FIG. 14 is a flow chart showing one exemplary procedure of document list display processing performed by the output apparatus according to Embodiment 2.

### DESCRIPTION OF THE EMBODIMENTS

The following describes embodiments of the present disclosure with reference to the drawings.

### Embodiment 1

### Network Configuration of Remote Hold Printing System

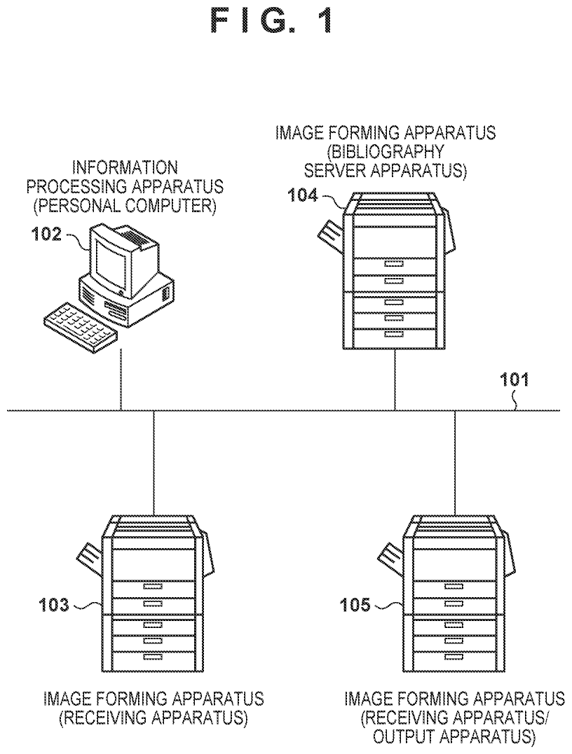

FIG. 1 is a diagram showing a network configuration to which a multifunction peripheral that is an image forming apparatus according to Embodiment 1 of the present disclosure can be applied. In FIG. 1, a network 101 supports TCP/IP protocols, for example. A personal computer 102, which is an information processing apparatus, and multifunction peripherals 103 to 105 are connected to the network 101.

For example, the multifunction peripheral 103 is a document receiving apparatus that, upon receiving a print job from the personal computer 102, performs printing or stores (in other words, saves or retains) print data that is included in the print job to perform printing later. The multifunction peripheral 103 extracts bibliographic information from the received print job and transmits the extracted bibliographic information to the multifunction peripheral 104. The multifunction peripheral 104 is a bibliography server apparatus (also referred to as a “bibliography server”) that unitarily manages bibliographic information regarding print data stored in other multifunction peripherals. The multifunction peripheral 105 is a document receiving apparatus that receives print jobs, and also functions as an output apparatus that acquires bibliographic information from the bibliography server apparatus 104 based on authentication information, receives retained print data from the document receiving apparatus 103 based on the acquired bibliographic information, and performs printing.

The above-described configuration is a general configuration described to facilitate understanding, and it goes without saying that it is also possible to employ a configuration including a plurality of personal computers 102, a plurality of document receiving apparatuses 103, and/or a plurality of document receiving apparatuses/output apparatuses 105. Also, the multifunction peripherals 103 to 105 each operate as both a document receiving apparatus and an output apparatus. That is, each multifunction peripheral in this system operates as both a document receiving apparatus and an output apparatus, and one of the multifunction peripherals operates as a bibliography server apparatus.

Schematic Configuration of Multifunction Peripherals 103 to 105

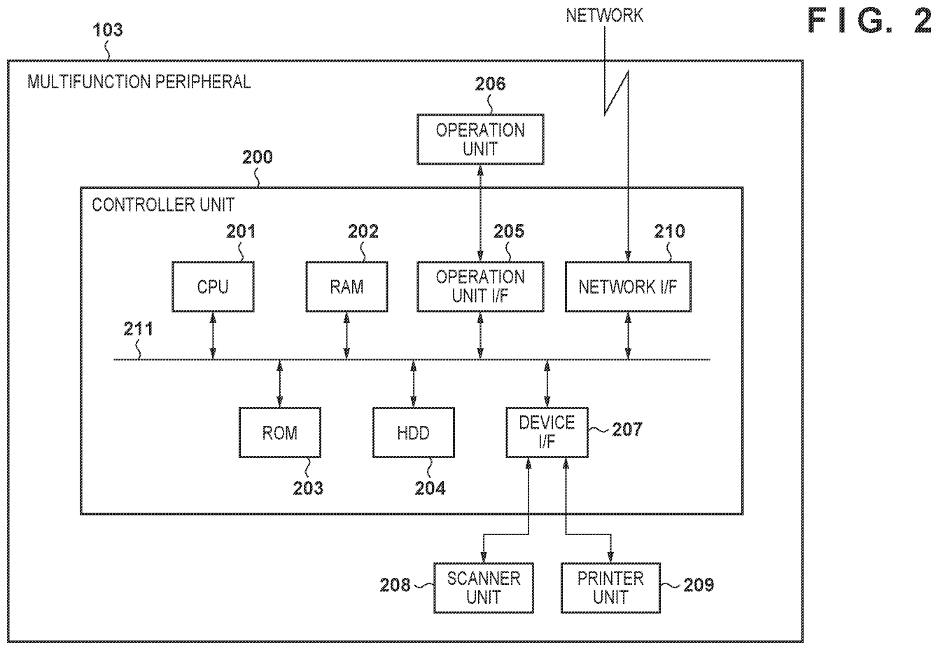

FIG. 2 is a block diagram showing a schematic configuration of each of the multifunction peripherals 103, 104, and 105 according to Embodiment 1 of the present disclosure. The multifunction peripheral 103 will be described with reference to FIG. 2 to simplify the description.

In FIG. 2, the multifunction peripheral 103 is constituted by a controller unit 200, an operation unit 206, a scanner unit 208, and a printer unit 209.

The controller unit 200 is an apparatus that controls the multifunction peripheral or printer. The controller unit 200 is constituted by a CPU 201, a RAM 202, a ROM 203, a HDD 204, an operation unit I/F 205, a device I/F 207, and a network I/F 210, which are connected to each other via a system bus 211.

The CPU 201 controls the entire image forming apparatus 103 by comprehensively controlling the apparatuses connected to the system bus 211. Programs, such as an operating system, system software, and application software, and data are stored in the RAM (Random Access Memory) 202. A boot program for a system, a system program, and application programs are stored in the ROM (Read Only Memory) 203. In some cases, information that is necessary for the image forming apparatus, such as fonts, is also stored. The HDD 204 is a hard disk drive in which the operating system, system software, application software, image data, settings data, etc. are stored. Hold printing jobs may also be stored in the HDD 204. Further, if the image forming apparatus 103 functions as a bibliography server, bibliographic information may also be stored in the HDD 204. Note that bibliographic information can also be stored as an in-memory database on the RAM 202 to increase the processing speed. The programs stored in the RAM 202 are executed by the CPU (Central Processing Unit) 201 to process image data and data other than images, which are stored in the RAM 202, the ROM 203, or the HDD 204. In the case of a small multifunction peripheral, a configuration is sometimes employed in which the HDD 204 is not provided and system software, application software, etc. are stored in the ROM 203. Alternatively, a configuration is also possible in which a storage device other than a hard disk, for example, an SSD (Solid State Disk) using a flash memory, is used instead of the HDD 204.

The operation unit I/F 205 is an interface unit interfaced to the operation unit 206 that includes a touch panel, and outputs image data to be displayed in the operation unit 206 to the operation unit 206. Also, the operation unit I/F 205 transmits information input by the user through the operation unit 206 to the CPU 201. The operation unit 206 displays, for example, a user interface screen on the touch panel. It is possible to display, on the user interface, a list of bibliographic information regarding hold printing jobs and a list of bibliographic information acquired from the bibliography server, for example. Print jobs can be identified using bibliographic information, and accordingly a list of bibliographic information displayed on the user interface can also be called a list of print jobs.

The device I/F 207 connects the scanner unit 208 and the printer unit 209, which are image input/output devices, to the controller unit 200, and inputs or outputs image data. Image data input from the scanner unit 208 through the device I/F 207 is stored in the RAM 202 or the HDD 204. Image processing or the like is performed on the stored image data as necessary, using application programs stored in the RAM 202. Also, image data is output through the device I/F 207 to the printer unit 209. The network I/F 210 is connected to a network, and image data or information for controlling the multifunction peripheral is input from or output to external devices on the network via the network I/F 210.

It goes without saying that there is no limitation to the configuration shown in FIG. 2, and a configuration other than that shown in FIG. 2 can also be employed so long as the effects of the present disclosure can be achieved. For example, in the case of a multifunction peripheral that has a facsimile (FAX) function, a configuration is also possible in which the controller unit 200 includes an I/F for a modem apparatus, which is not shown in FIG. 2, and FAX transmission is enabled by establishing a connection to a public line using a modem. Alternatively, the controller unit 200 may also include a Universal Serial Bus (USB) I/F (not shown) to enable reading and printing of data that is stored in a flash memory card etc., for example.

Software Configuration of Multifunction Peripherals 103 to 105

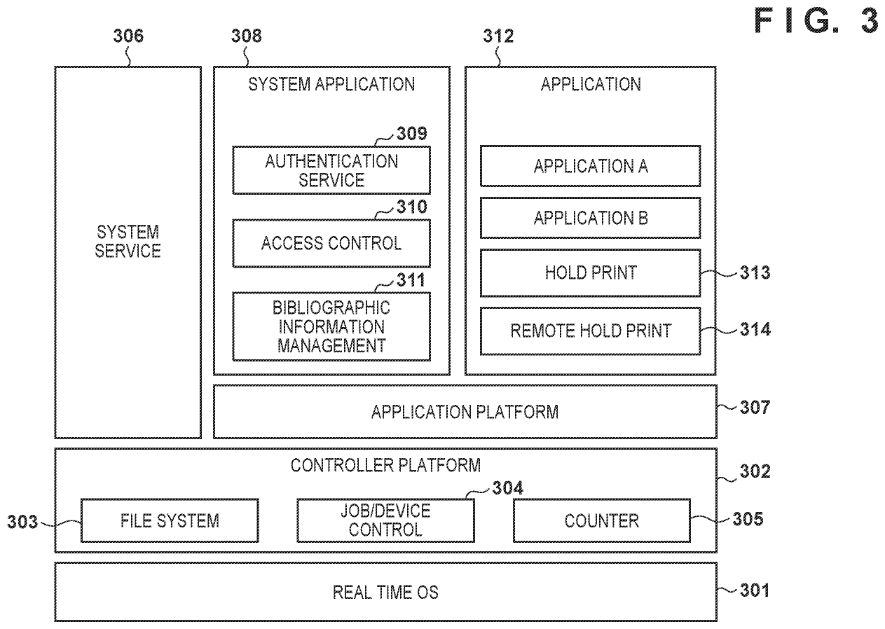

FIG. 3 is a block diagram showing a software configuration of each of the multifunction peripherals 103 to 105 according to Embodiment 1 of the present disclosure, which is implemented in the controller unit 200. Software that is incorporated in the multifunction peripheral or printer and is processed by the controller unit 200 is installed as so-called firmware, and is executed by the CPU 201.

Real time OS 301 provides software that runs on the real time OS 301 with services and frameworks for various types of resource management, which are optimized to control embedded systems. The services and frameworks for various types of resource management provided by the real time OS include multi-task management for running a plurality of processes substantially in parallel by managing a plurality of execution contexts of processes performed by the CPU 201, and inter-task communication that realizes synchronization and data exchange between tasks. Further, the real time OS 301 also provides memory management, interruption management, various device drivers, and a protocol stack in which processes of various protocols for a local interface, a network, communication, etc. are implemented, for example.

A controller platform 302 is constituted by a file system 303, job/device control 304, a counter 305, etc. The file system 303 is a mechanism for storing data constructed on a storage device, such as the HDD 204 or the RAM 202, and is used to spool jobs to be handled by the controller unit 200 or store various types of data. The job/device control 304 controls hardware of the multifunction peripheral or printer, and mainly controls jobs that use basic functions (printing, scanning, communication, image transformation, etc.) provided by the hardware. The counter 305 manages the expiration date of each application and counter values of printing and scanning.

A system service 306 is a module for monitoring the operation state of the multifunction peripheral or printer and downloading software and a license from a software distribution server via a network. An application platform 307 is middleware that enables use of the real time OS 301 and the mechanism of the controller platform 302 from a system application 308, which is described below, or applications 312 that can be added.

The system application 308 is constituted by an authentication service 309, access control 310, and bibliographic information management 311. The authentication service 309 performs user authentication by checking a user name and a password that are input through the operation unit 206 or a network against a user database that is stored in the HDD 204. It is also possible to perform authentication using an external authentication server, such as ActiveDirectory, rather than holding a user database in the HDD 204. The access control 310 is a security module for permitting or forbidding jobs or access to various resources, based on user authority or security settings that are set for data. The bibliographic information management 311 is a module that is implemented in the bibliography server apparatus, the document receiving apparatus, and the output apparatus, and manages, with respect to each user, bibliographic information regarding print data that is stored in multifunction peripherals that are connected to each other via a network. Bibliographic information includes information regarding print data (document) that is input to a multifunction peripheral, such as the received date/time of the print data, the IP address of the multifunction peripheral storing the print data or a directory path in a local device, print data name, print settings, etc.

Each application 312 is a module that is capable of displaying a menu in the operation unit 206 and accepting input from the user, and provides the user with various functions that are realized by the multifunction peripheral or printer. A hold printing application 313 is one of the applications 312, and displays a document list that shows a list of hold printing data, deletes print data, performs retention determination upon receiving print jobs, and performs print output processing, etc. A remote hold printing application 314 is one of the applications 312, and has the functions of the hold printing application 313 as well as a function that enables display and operation of not only a list of print data retained in the multifunction peripheral that is being operated, but also a list of print data retained in other multifunction peripherals.

Description of Application Selection Screen

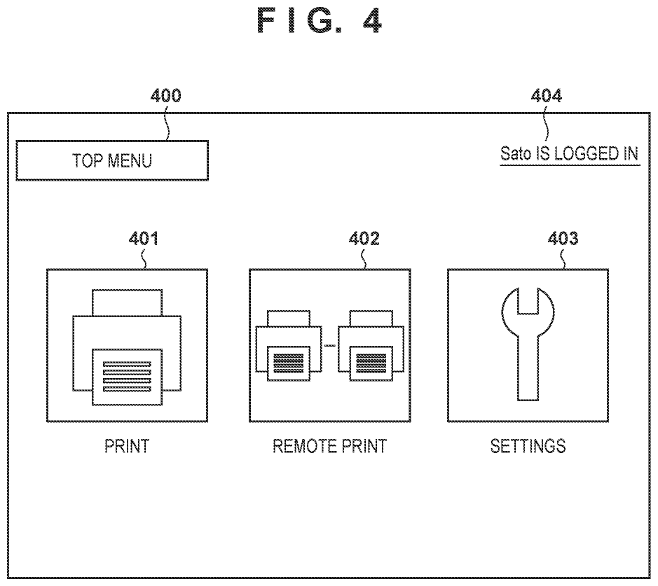

FIG. 4 shows one example of an application selection screen that is displayed in the multifunction peripheral 105, which is an output apparatus according to Embodiment 1. This screen is displayed in the operation unit 206 of the multifunction peripheral 105.

After a user logs in to the multifunction peripheral 105 using an IC card or the like, a top menu 400 is displayed to allow the user to select an application to be used, from the top menu 400. Since the user has logged in to the multifunction peripheral 105, a logged in user name 404 is displayed on the screen. In the illustrated example of the screen, the user name “Sato” is displayed in the login state.

The top menu 400 displays icons for respective applications 312. A print icon 401 is the icon for the hold printing application 313, and the hold printing application 313 is activated as a result of the print icon 401 being touched. Note that, although operations made on a touch panel are mainly made by touching the touch panel, an operation made by touching the touch panel is also referred to as “pressing” in the present embodiment. A remote print icon 402 is the icon for the remote hold printing application 314, and the remote hold printing application 314 is activated as a result of the remote print icon 402 being touched. A setting icon 403 is the icon for an application for performing setting regarding the multifunction peripheral 105, the application being one of the applications 312.

Description of Document List Screen

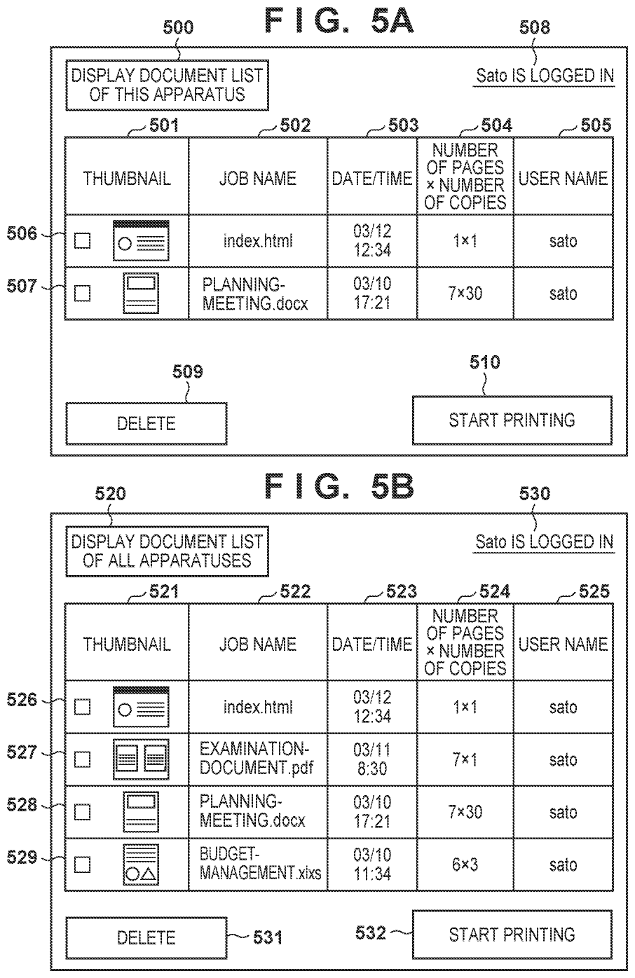

FIGS. 5A and 5B each show one example of a document list screen that is displayed in the multifunction peripheral 105, which is the output apparatus according to Embodiment 1. These screens are displayed in the operation unit 206 by the hold printing application 313 and the remote hold printing application 314, which are executed by the CPU 201 of the multifunction peripheral 105. The document list screen displays a list of print jobs or a list of print data that is held by an authenticated user. Print jobs or print data displayed on the document list screen indicates documents (or print jobs) that can be output targets (or printing targets).

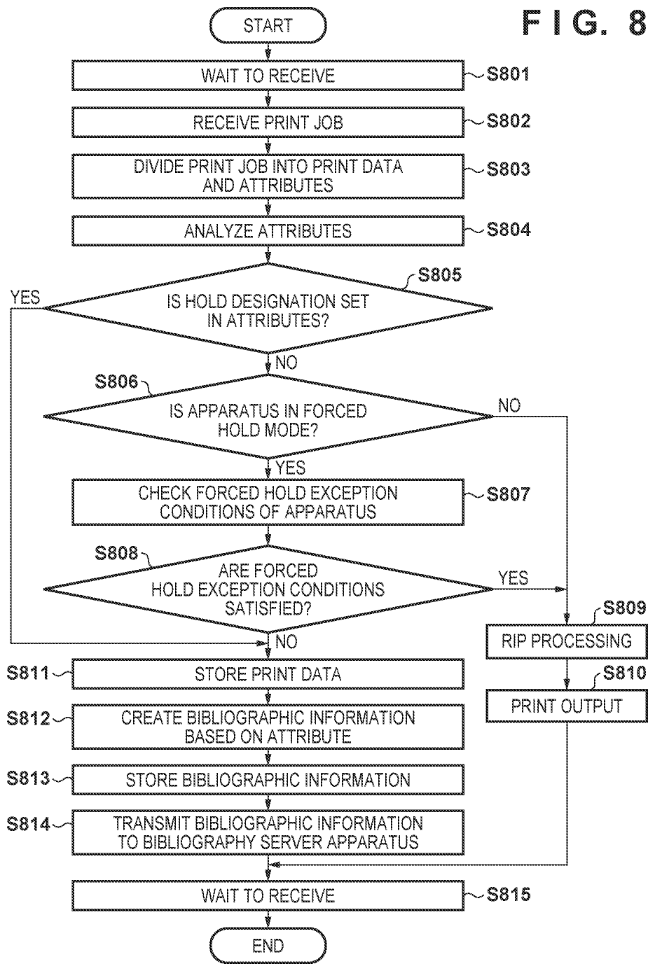

FIG. 5A shows a document list screen of the hold printing application 313, which is displayed as a result of the print icon 401 being touched. A document list is created based on bibliographic information that is stored in the HDD 204 in step S813 in FIG. 8. In the illustrated example of the screen, the user name “Sato” is displayed in the login state. With respect to each document list, a thumbnail 501, a job name 502, received date/time 503, number of pages x number of copies 504, and a user name 505 are displayed. Two pieces of print data (506 and 507) can be printed or deleted via this screen. The hold printing application 313 can display only print data that is stored in the multifunction peripheral being operated, and accordingly the two pieces of data are stored in the HDD 204 of the multifunction peripheral 105. 509 denotes a delete button, 510 denotes a print start button, and, as a result of the user selecting desired print data from the list and pressing one of these buttons, the target print data is deleted or printed. 508 denotes a logged in user.

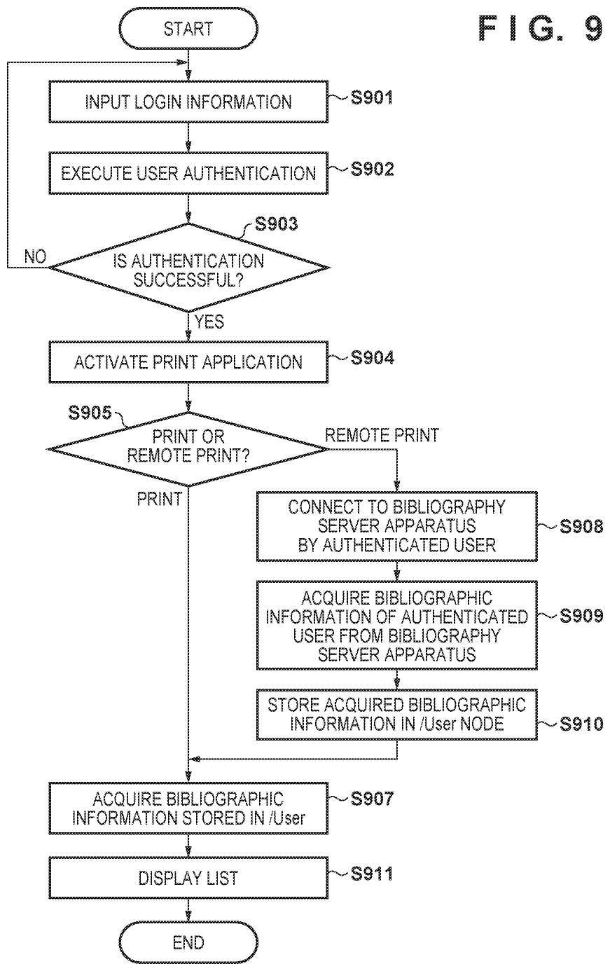

FIG. 5B shows a document list screen of the remote hold printing application 314, which is displayed as a result of the remote print icon 402 being touched. A document list is created based on bibliographic information that is stored in the HDD 204 in step S910 in FIG. 9. In the illustrated example of the screen, the user name “Sato” is displayed in the login state. With respect to each document list, a thumbnail 521, a job name 522, received date/time 523, number of pages x number of copies 524, and a user name 525 are displayed. Four pieces of print data (526 to 529) can be printed or deleted via this screen. The remote hold printing application 314 can also display print data stored in the multifunction peripheral being operated, and accordingly the four pieces of data are stored in the HDD 204 of the multifunction peripheral 105 and the HDD 204 of the multifunction peripheral 103. 531 denotes a delete button, 532 denotes a print start button, and, as a result of the user selecting desired print data from the list and pressing one of these buttons, the target print data is deleted or printed. 530 denotes a logged in user.

Actual Form of Bibliographic Information

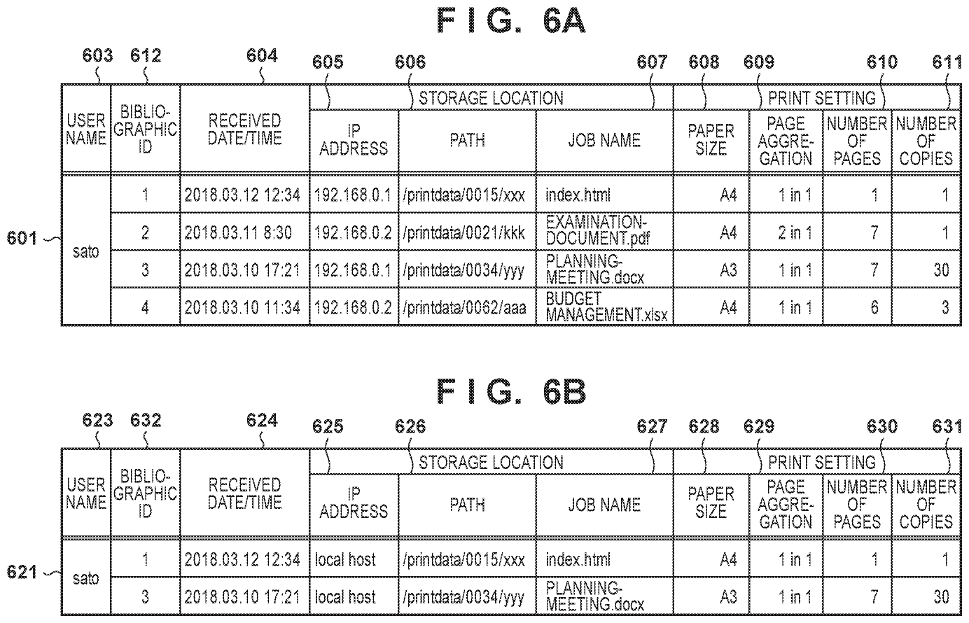

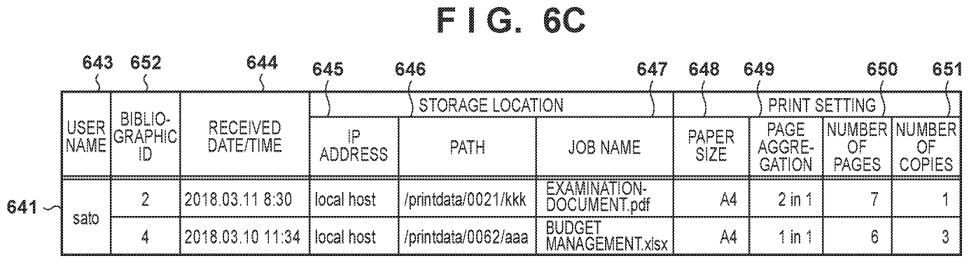

FIGS. 6A to 6C are diagrams showing one example of an actual form of bibliographic information that is managed with respect to each user by the bibliographic information management 311.

FIG. 6A shows four pieces of bibliographic information as an example of bibliographic information that is managed by the bibliographic information management 311 of the bibliography server apparatus 104. These pieces of bibliographic information are created by the document receiving apparatuses 103 and 105, transmitted to the bibliography server apparatus 104, and managed by the bibliography server apparatus 104. That is, the bibliography server apparatus 104 manages bibliographic information regarding all print data retained in multifunction peripherals that are included in the system and support remote hold printing. Bibliographic information 601 includes a user name 603, a bibliography ID 612, received date/time 604, a storage IP address 605, a directory path 605, a job name 607 of print data, a paper size 608, page aggregation 609, number of pages 610, and number of copies 611. Here, bibliographic information regarding a user who has the user name 603 “Sato” is shown. The received date/time 604 is information that indicates the date and time at which a pint job was received. The storage IP address 605 indicates the IP address of a multifunction peripheral that stores print data, and the directory path 606 indicates the path to a directory in which the print data is stored. That is, the storage IP address 605 and the directory path 606 are information for specifying the storage location (or saving location) of the print data. Print settings 608 to 611 are set through a printer driver using an application that runs on the personal computer 102. It goes without saying that other print settings may also be held. A configuration is also possible in which bibliographic information includes a print finished flag that indicates whether or not print data has already been printed, although this is not shown in FIGS. 6A to 6C.

FIG. 6B shows two pieces of bibliographic information as an example of bibliographic information that is managed by the bibliographic information management 311 of the document receiving apparatus 103. FIG. 6C shows two pieces of bibliographic information as an example of bibliographic information that is managed by the bibliographic information management 311 of the document receiving apparatus/output apparatus 105.

The bibliography server apparatus 104 collects bibliographic information from each multifunction peripheral and accordingly holds bibliographic information stored in the document receiving apparatus 103 and the document receiving apparatus/output apparatus 105, but the document receiving apparatus 103 and the document receiving apparatus/output apparatus 105 are not bibliography server apparatuses and accordingly store only bibliographic information regarding print jobs that they themselves have received (i.e., that have been input to themselves). Therefore, IP addresses 625 and 645 of the multifunction peripherals storing print data are displayed as “localhost”, which indicates a loopback address, and the management target is bibliographic information regarding print jobs stored in the self apparatus.

Saving Format of Bibliographic Information

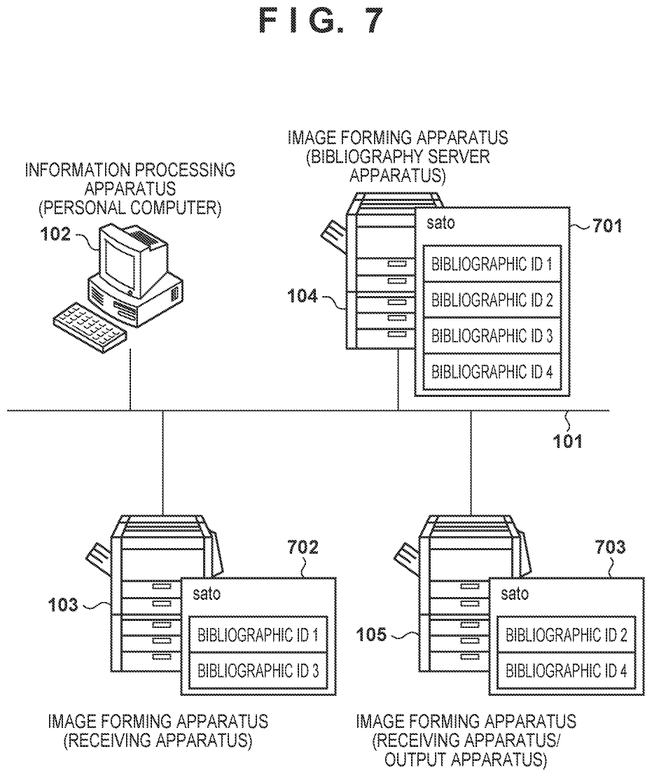

FIG. 7 is a diagram showing one example of a saving format of bibliographic information stored in each multifunction peripheral. A bibliographic information list 701 shows the saving format of bibliographic information stored in the bibliography server apparatus 104, and includes the user name 603 “Sato” as the head node and four pieces of bibliographic information that are respectively created in the multifunction peripherals, transmitted to the bibliography server apparatus, and stored under the head node. A bibliographic information list 702 shows the saving format of bibliographic information stored in the document receiving apparatus 103, and includes the user name 623 “Sato” as the head node and bibliographic information regarding two pieces of print data input to the document receiving apparatus 103, which is stored under the head node. A bibliographic information list 703 shows the saving format of bibliographic information stored in the document receiving apparatus/output apparatus 105, and includes the user name 643 “Sato” as the head node and bibliographic information regarding two pieces of print data input to the document receiving apparatus/output apparatus 105, which is stored under the head node.

Print Job Transmission Procedure

The following describes one example of a procedure that is executed when a print job is transmitted by the user from the personal computer 102 to the multifunction peripheral 103, which is the document receiving apparatus. In the following description, assume that authentication management is performed by the authentication service 309 in the multifunction peripheral 103.

In the present embodiment, an example will be described in which Page Description Language (PDL) data is transmitted as print data to the multifunction peripheral 103. Examples of PDLs include Printer Command Language (PCL) and PostScript (registered trademark) of Adobe Inc., and the multifunction peripheral 103 performs printing by analyzing the PDL and performing Raster Image Processing (RIP processing). Note that print data is only required to have a format that can be analyzed and printed by the multifunction peripheral 103, and may have a format other than PDL data, for example, image data, such as TIFF, or a document format of an application.

The user activates the printer driver using an application that runs on the personal computer 102. The user sets print settings using a printer driver screen (not shown), and then selects the multifunction peripheral 103 and gives a print instruction. Here, the user can also give an explicit instruction for hold printing.

Upon accepting the print instruction, the printer driver displays an authentication screen (not shown). The user inputs authentication information and then gives a print instruction. The printer driver transmits an authentication request together with a user name and a password to the multifunction peripheral 103. The authentication service 309 of the multifunction peripheral 103 checks the received user name and password, and transmits an authentication result to the personal computer. The printer driver receives the authentication result, and if the authentication is not successful, ends print processing with an error.

If the authentication is successful, the printer driver creates print data by converting application data into the PDL. Further, the printer driver creates a print job by including user information and designated print settings in the print data. The printer driver transmits the created print job to the multifunction peripheral 103.

Here, if the personal computer 102 and the multifunction peripheral 103 are in the same authentication domain and the result of authentication performed by the personal computer 102 is guaranteed, a configuration is also possible in which the authentication request is not issued to the multifunction peripheral 103 and user information held by the personal computer 102 is used. Alternatively, a configuration is also possible in which authentication processing performed by the printer driver is omitted and user information that is registered in the printer driver in advance is used.

Print Job Receiving Procedure

FIG. 8 is a flow chart showing one exemplary procedure of print job receiving processing that is executed by the CPU 201 of the multifunction peripheral 103 or 105, which is a document receiving apparatus according to Embodiment 1. S801 to S815 denote steps.

First, in step S801, the job/device control 304 waits to receive a print job. In step S802, upon receiving a print job via the network I/F 207, the job/device control 304 notifies the hold printing application 313.

In step S803, the hold printing application 313 divides the received print job into print data that is constituted by the PDL and is the target of rendering and attribute data that includes user information and designated print settings.

In step S804, the hold printing application 313 analyzes the separated attribute data. In step S805, the hold printing application 313 refers to the attribute data and determines whether or not retention is designated. If it is determined in step S805 that retention is designated, processes in step S811 and the following steps are performed.

If it is determined in step S805 that retention is not designated, the hold printing application 313 determines, in step S806, whether or not the multifunction peripheral 103 is in a forced hold mode. If the multifunction peripheral 103 is not in the forced hold mode, processes in step S809 and the following steps are performed. The forced hold mode is, for example, a setting of the document receiving apparatus for storing (retaining) received print jobs in principle regardless of retention setting values of the print jobs. The forced hold mode may be set via a settings screen that is displayed as a result of the setting icon 403 being touched, for example.

If it is determined in step S806 that the multifunction peripheral 103 is in the forced hold mode, the hold printing application 313 checks forced retention exception conditions of the multifunction peripheral 103 in step S807.

In step S808, the hold printing application 313 determines whether or not the forced retention exception conditions are satisfied, based on the type of PDL constituting the print data included in the received print job or information regarding the source of the print request. If the exception conditions are satisfied, printing is performed without retaining the print data, and accordingly the processing advances to print processing that is performed in step S809 and the following steps.

In step S809, the job/device control 404 performs RIP processing on the PDL data, which is the print data, in accordance with print settings, and performs printing in step S810 by giving a print instruction to the printer unit 209 via the device I/F 207.

If it is determined in step S808 that the forced retention exception conditions are not satisfied, in step S811, the hold printing application 313 stores the print data received in step S802 in the HDD 204 of the multifunction peripheral 103.

In step S812, the hold printing application 313 creates bibliographic information (described with reference to FIGS. 6A to 6C) based on attribute data.

In step S813, the hold printing application 313 stores the created bibliographic information in the HDD 204 of the multifunction peripheral 103.

In step S814, the hold printing application 313 transmits a request for registering the created bibliographic information to the bibliography server apparatus 104. Upon receiving the request, the bibliography server apparatus 104 stores the received bibliographic information (see FIG. 6A).

In step S815, the hold printing application 313 returns to the state of waiting to receive a print job.

Thus, a series of processes that are performed when receiving a document ends.

Document List Display Procedure

FIG. 9 is a flow chart showing one exemplary procedure of document list display processing that is executed by the CPU 201 of the multifunction peripheral 105, which is the document receiving apparatus/output apparatus according to Embodiment 1. S901 to S911 denote steps.

First, in step S901, the authentication service 309 displays an authentication screen (not shown) and waits for authentication information to be input. Upon accepting input of authentication information from the user, the operation unit 206 transmits the authentication information to the authentication service 309 via the operation unit I/F 205 (step S902).

In step S902, the authentication service 309 performs user authentication. In step S903, it is determined whether or not the authentication was successful, and if it is determined that the authentication was successful, the authentication service 309 notifies each application 312 of the authentication result, and processes in step S904 and the following steps are performed. If it is determined in step S903 that the authentication was not successful, the processing returns to the process performed in step S901.

In step S904, the hold printing application 313 or the remote hold printing application 314 is activated as a result of the print application icon 401 or 402 being touched by the user.

In step S905, the processing advances to step S907 if the hold printing application 313 has been activated, or the processing advances to step S908 if the remote hold printing application 314 has been activated.

In step S908, the remote hold printing application 314 connects to the bibliography server apparatus 104 via a network using authenticated user information.

In step S909, the remote hold printing application 314 requests bibliographic information regarding the authenticated user from the connected bibliography server apparatus 104, and acquires the bibliographic information from the bibliography server apparatus 104. For example, if the user name of the logged in user is “Sato”, a request for bibliographic information regarding the user “Sato” is given to the bibliography server apparatus 104, and bibliographic information associated with the user name 603 “Sato” is acquired out of the bibliographic information shown in FIGS. 6A to 6C.

In step S910, the remote hold printing application 314 stores, in the HDD 204, the bibliographic information regarding the authenticated user, which has been acquired from the bibliography server apparatus 104, under the user name 643 “Sato”, which is the head node.

In step S907, the hold printing application 313 or the remote hold printing application 314 acquires bibliographic information that includes the user name 643 “Sato” as the head node. At this time, the remote hold printing application 314 acquires the bibliographic information including the bibliographic information that has been acquired from the bibliography server apparatus 104 and stored in step S910.

In step S911, the hold printing application 313 or the remote hold printing application 314 displays, in the operation unit 206, a list (document list) 500 or 520 of print data that can be printing targets and deletion targets, based on the acquired bibliographic information, and then ends a series of processes.

Bibliographic Information Processing Procedure Executed by Bibliography Server Apparatus

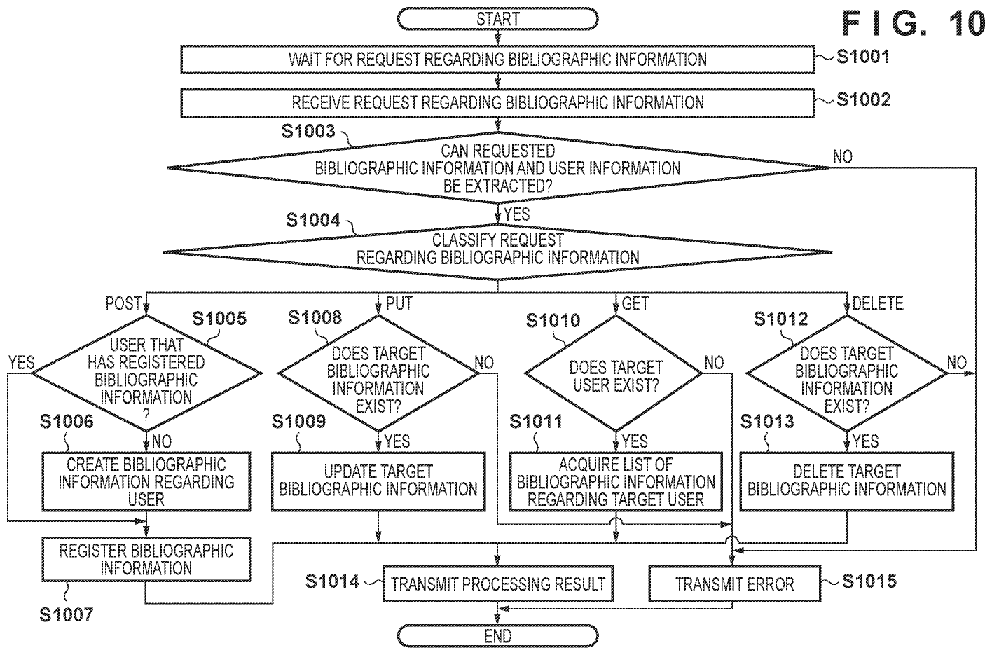

FIG. 10 is a flow chart showing one exemplary procedure of bibliographic information management that is executed by the CPU 201 of the multifunction peripheral 104, which is the bibliography server apparatus according to Embodiment 1. S1001 to S1015 denote steps.

First, in step S1001, the remote hold printing application 314 running on the CPU 201 of the multifunction peripheral 104 waits for a request to be issued from the multifunction peripheral 103, 104, or 105, regarding bibliographic information.

In step S1002, the remote hold printing application 314 receives a request regarding bibliographic information issued from the multifunction peripheral 103, 104, or 105.

In step S1003, the remote hold printing application 314 determines whether the requested bibliographic information and user information can be extracted from the received request. If the information cannot be extracted, the processing advances to step S1015, an error is transmitted, and the processing ends.

In step S1004, the remote hold printing application 314 diverges the processing according to the type of the request regarding bibliographic information. If it is determined in step S1004 that new registration (POST) of bibliographic information is requested, the processing advances to step S1005 and the remote hold printing application 314 performs bibliographic information registration processing.

In step S1005, the remote hold printing application 314 determines whether bibliographic information that is to be newly registered is bibliographic information regarding an already registered user. If the bibliographic information to be newly registered is bibliographic information regarding an unregistered user, bibliographic information regarding the user is created in step S1006.

In step S1007, the remote hold printing application 314 newly registers the target bibliographic information.

If it is determined in step S1004 that an update (PUT) of bibliographic information is requested, the processing advances to step S1008 and the remote hold printing application 314 executes processing for updating the target bibliographic information.

In step S1008, the remote hold printing application 314 determines whether or not the bibliographic information to be updated exists. If the bibliographic information to be updated does not exist, an error is transmitted in step S1015 and a series of processes ends. If the bibliographic information to be updated exists, the remote hold printing application 314 updates the target bibliographic information in step S1009.

If it is determined in step S1004 that acquisition (GET) of bibliographic information is requested, the processing advances to step S1010 and the remote hold printing application 314 executes processing for acquiring the target bibliographic information.

In step S1010, the remote hold printing application 314 determines whether or not a target user with respect to whom the bibliographic information is to be acquired exists. If the target user does not exist, an error is transmitted in step S1015 and a series of processes ends. If the target user exists, the remote hold printing application 314 acquires a list of bibliographic information regarding the target user in step S1011.

If it is determined in step S1004 that deletion (DELETE) of bibliographic information is requested, the processing advances to step S1012 and the remote hold printing application 314 executes processing for deleting the target bibliographic information.

In step S1012, the remote hold printing application 314 determines whether or not the bibliographic information to be deleted exists. If the bibliographic information to be deleted does not exist, an error is transmitted in step S1015 and a series of processes ends. If the bibliographic information to be deleted exists, the remote hold printing application 314 deletes the target bibliographic information in step S1013.

In step S1014, in response to each request, the remote hold printing application 314 transmits a processing result to the image forming apparatus that issued the request, and ends a series of processes.

Printing Procedure

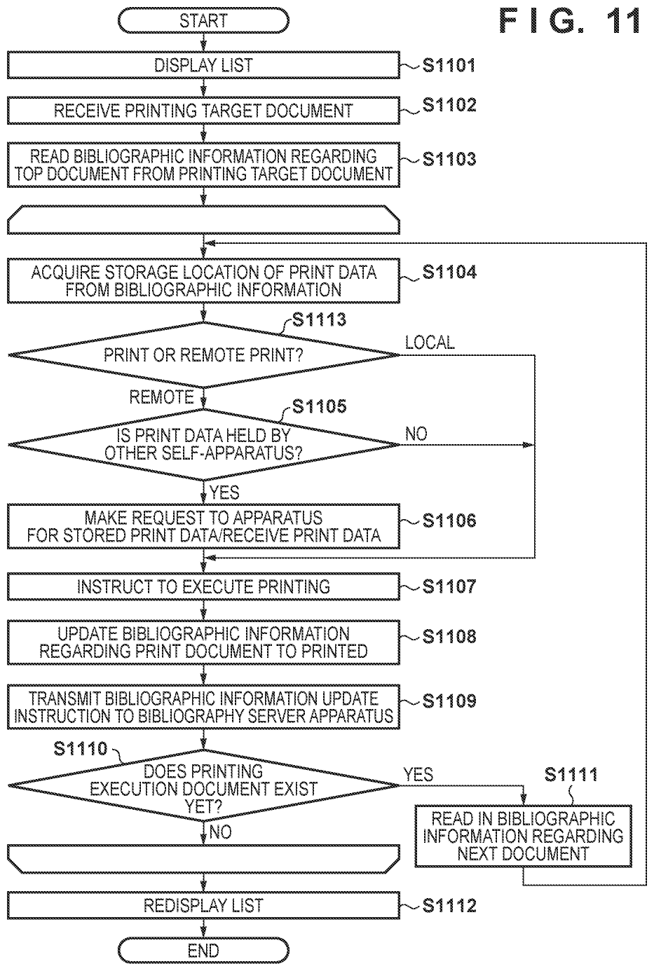

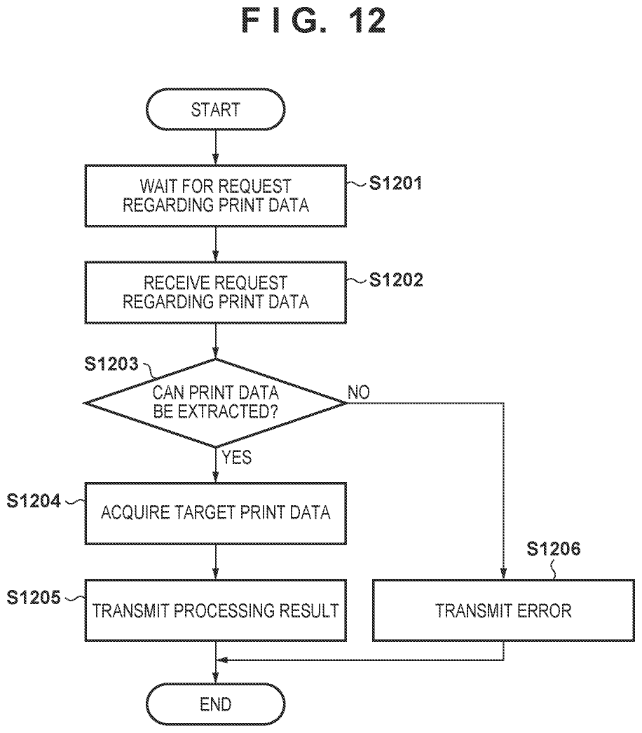

FIG. 11 is a flow chart showing one exemplary procedure of print processing that is executed by the CPU 201 of the multifunction peripheral 105, which is the output apparatus according to Embodiment 1, when the print start button 510 or 532 is pressed by the user with respect to a selected document. S1101 to S1113 denote steps.

First, in step S1101, the hold printing application 313 or the remote hold printing application 314 displays a document list (FIG. 5A or 5B) in the operation unit 206 of the multifunction peripheral 105.

In step S1102, the hold printing application 313 or the remote hold printing application 314 receives, from the application platform 307, selected document information that indicates print data selected by the user as a printing target from documents 506 and 507 or documents 526 to 529 in the displayed document list.

In step S1103, the hold printing application 313 or the remote hold printing application 314 reads bibliographic information regarding print data at the top of the received selected document information from the HDD 204.

Steps S1104 to S1111 and S1113 are repeatedly executed sequentially focusing on print jobs that are selected as printing targets. In step S1104, the hold printing application 313 or the remote hold printing application 314 extracts the storage location 645 and 646 of print data that is included in the bibliographic information.

In step S1113, the processing advances to step S1107 if the hold printing application 313 is running as a result of the user having touched the print icon 401. In contrast, in step S1113, the processing advances to step S1105 if the remote hold printing application 314 is running as a result of the user having touched the remote print icon 402.

In step S1105, the remote hold printing application 314 determines whether the print data is held by the self apparatus, which is the multifunction peripheral 105, or another apparatus, based on the extracted storage location of the print data. The determination performed in step S1105 is determination as to which of the self apparatus and another apparatus is holding the print data, and accordingly can be made depending on whether the IP address matches the IP address of the self apparatus, for example. If the print data is held by another apparatus, the processing advances to step S1106.

In step S1106, the remote hold printing application 314 requests, via the network I/F 210, the document receiving apparatus 103 storing the print data to transmit the print data, and receives the print data from the document receiving apparatus 103.

In step S1107, the hold printing application 313 or the remote hold printing application 314 acquires print data that is retained in the HDD 204 or the print data acquired from the document receiving apparatus 103 in step S1106. After the print data is acquired, print processing is performed through the application platform 307.

In step S1108, the hold printing application 313 or the remote hold printing application 314 updates bibliographic information by setting a print finished flag to the bibliographic information regarding the printed print data, and stores the updated bibliographic information in the HDD 204.

In step S1109, the hold printing application 313 or the remote hold printing application 314 transmits a bibliographic information update request to the bibliography server apparatus 104.

In step S1110, the hold printing application 313 or the remote hold printing application 314 checks whether or not all print data for which a print instruction has been received was printed.

If there is unprinted print data, bibliographic information regarding the next print data is read in step S1111 and the processes in step S1104 and the following steps are repeated.

If it is confirmed in step S1110 that all print data has been printed, the processing advances to step S1112, and the hold printing application 313 or the remote hold printing application 314 again displays a document list in which printed print data is not displayed, in the operation unit 206. Thus, a series of print processes ends.

FIG. 12 is a flow chart showing processing that is executed by the CPU 201 of the multifunction peripheral 103, which is the document receiving apparatus according to Embodiment 1, when a request regarding retained print data is received by the multifunction peripheral 103. S1201 to S1206 denote steps.

First, in step S1201, the remote hold printing application 314 waits to receive a request regarding print data from the multifunction peripheral 104 or 105. In step S1202, the remote hold printing application 314 receives a request regarding print data. Examples of requests received in this step include a print data transmission request that is transmitted from the multifunction peripheral 105, which is the output apparatus, in step S1106 in FIG. 11. In step S1203, the remote hold printing application 314 determines whether or not the request target print data can be extracted. If the print data cannot be extracted, that is, if the target print data is not stored in the HDD 204, the processing advances to step S1206, and the remote hold printing application 314 transmits error information to the source of the request, and ends a series of processes.

If it is determined in step S1203 that the print data can be extracted, the processing advances to step S1204, and the remote hold printing application 314 acquires the target print data by reading it from the HDD 204.

In step S1205, the remote hold printing application 314 transmits a processing result regarding the acquired print data to the source of the request. If the request received in step S1202 is a print data transmission request, the target print data is transmitted to the source of the request. Alternatively, if the received request is a print data deletion request, the target print data is deleted, and a notification of completion of the deletion is transmitted to the source of the request. Thus, a series of processes ends.

With the above-described configurations and procedures, the invention according to the present embodiment makes it possible to further provide a bibliography server in an image forming system that is constituted by image forming apparatuses, and unitarily manage bibliographic information regarding hold printing jobs that are stored in the image forming apparatuses, using the bibliography server. Accordingly, even when remote hold printing is performed using an output apparatus, a list of hold printing jobs that can be printing targets can be acquired by merely accessing the bibliography server, and the list of printing target jobs can be immediately presented to the user without causing the user to feel any stress. Accordingly, the effects become more noticeable as the number of image forming apparatuses that function as document receiving apparatuses connected to the image forming system increases.

Note that, in the present embodiment, the bibliography server is one of the image forming apparatuses connected to the image forming system, but a configuration is also possible in which a personal computer functions as the bibliography server, for example.

### Embodiment 2

In Embodiment 1, an example is described in which hold printing and remote hold printing are dynamically switched, and bibliographic information stored in the self apparatus is used in the case of hold printing, and bibliographic information acquired from the bibliography server apparatus is used in the case of remote hold printing.

According to Embodiment 1, in the case of remote hold printing, a document list is displayed by acquiring bibliographic information from the bibliography server apparatus and storing the bibliographic information in the self apparatus, when displaying the list, and therefore display of the list may be delayed. Furthermore, there are cases in which bibliographic information that is acquired from the bibliography server apparatus and stored in the self apparatus overlaps with bibliographic information that is already stored in the self apparatus, and HDD resources are unnecessarily used.

Therefore, in Embodiment 2, an example will be described in which, in a method for managing bibliographic information in a multifunction peripheral that functions as an output apparatus, bibliographic information is acquired from a bibliography server when a user logs in to the output apparatus, and only bibliographic information regarding remote documents is stored in the output apparatus, as a node other than local documents. Note that remote documents mean print jobs or print data stored in other image forming apparatuses.

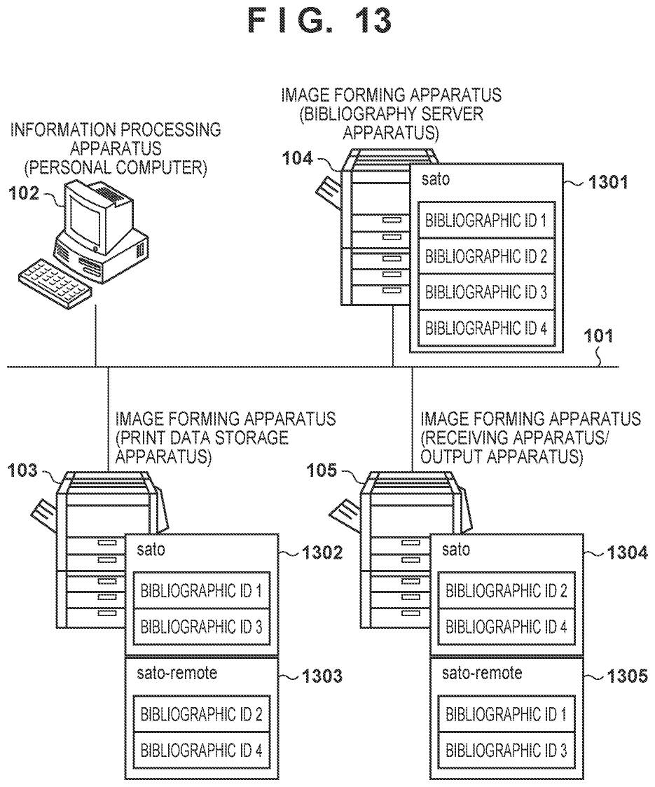

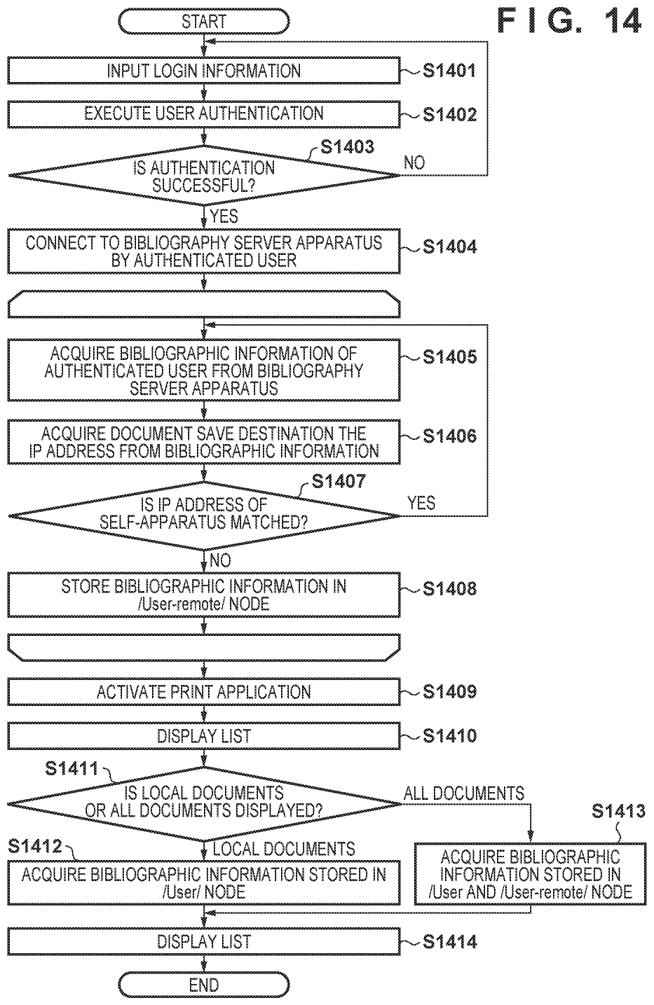

Major differences from Embodiment 1 are the saving configuration (FIG. 13) of bibliographic information and the acquisition timing of bibliographic information (step S1405 in FIG. 14), and Embodiment 2 is the same as Embodiment 1 except these points. Therefore, a description of matter that is common between Embodiments 1 and 2 is omitted.

Saving Format of Bibliographic Information

FIG. 13 is a diagram showing one example of a saving format of bibliographic information stored in each multifunction peripheral. Bibliographic information 1301 shows the saving format of bibliographic information stored in the bibliography server apparatus 104, and includes the user name 603 “Sato” as the head node and four pieces of bibliographic information that are respectively created in multifunction peripherals, transmitted to the bibliography server apparatus, and stored under the head node.

Bibliographic information 1302 and 1303 show the saving format of bibliographic information stored in the document receiving apparatus 103. The bibliographic information 1302 includes the user name 623 “Sato” as the head node and bibliographic information regarding two pieces of print data input to the document receiving apparatus 103, which is stored under the head node. The bibliographic information 1303 includes “Sato-remote” as the head node and bibliographic information regarding two pieces of print data, which is acquired from the bibliography server apparatus 104.

Bibliographic information 1304 and 1305 show the saving format of bibliographic information stored in the document receiving apparatus/output apparatus 105. The bibliographic information 1304 includes the user name 643 “Sato” as the head node and bibliographic information regarding two pieces of print data input to the document receiving apparatus/output apparatus 105, which is stored under the head node. The bibliographic information 1305 includes “Sato-remote” as the head node and bibliographic information regarding two pieces of print data, which is acquired from the bibliography server apparatus 104.

Document List Display Procedure

FIG. 14 is a flow chart showing one exemplary procedure of document list display processing that is executed by the CPU 201 of the multifunction peripheral 105, which is the document receiving apparatus/output apparatus according to Embodiment 2. S1401 to S1414 denote steps. In the present embodiment, the procedure shown in FIG. 14 is executed instead of the procedure shown in FIG. 9 of Embodiment 1.

First, in step S1401, the authentication service 309 displays an authentication screen (not shown), and waits for authentication information to be input. Upon accepting input of authentication information from the user, the operation unit 206 transmits the authentication information to the authentication service 309 via the operation unit I/F 205 (step S1402).

In step S1402, the authentication service 309 performs user authentication. In step S1403, it is determined whether or not the authentication was successful, and if it is determined that the authentication was successful, the authentication service 309 notifies each application 312 of the authentication result, and processes in step S1404 and the following steps are performed. If it is determined in step S1403 that the authentication was not successful, the processing returns to the process performed in step S1401.

In step S1404, after the authentication having been successfully performed, the remote hold printing application 314 connects to the bibliography server apparatus 104 via a network using authenticated user information, before display of a document list is requested.

Steps S1405 to S1408 are repeatedly executed focusing on each print job of the logged in user (authenticated user), which is acquired from the bibliography server apparatus 104. In step S1405, the remote hold printing application 314 requests bibliographic information regarding print jobs of the authenticated user from the connected bibliography server apparatus 104, and acquires the bibliographic information from the bibliography server apparatus 104. For example, if the user name of the logged in user is “Sato”, bibliographic information associated with the user name 603 “Sato” is acquired out of the bibliographic information shown in FIGS. 6A to 6C.

In step S1406, the remote hold printing application 314 acquires information regarding the IP address 605, which is information regarding the storage location of print data, from a piece of bibliographic information out of the acquired bibliographic information.

In step S1407, the remote hold printing application 314 compares the IP address 605 indicating the storage location of the print data with the IP address of the multifunction peripheral 105 functioning as the output apparatus, which is the self apparatus, and determines whether or not the IP addresses match. If the IP addresses do not match, the processing advances to step S1408. If the IP addresses match, the processing advances to step S1405 to perform the same processing on all other pieces of bibliographic information.

In step S1408, the remote hold printing application 314 stores the bibliographic information for which the IP address 605 indicating the storage location of the print data does not match with the IP address of the self apparatus, that is, bibliographic information regarding a remote document, using “Sato-remote” 601 as the head node. Through this processing, bibliographic information regarding local documents is stored and managed under the node “Sato”, and bibliographic information regarding remote documents is stored and managed under the node “Sato-remote”, without duplication of bibliographic information. After bibliographic information regarding print jobs of the logged in user has been acquired through the processes performed in steps S1405 to S1408, step S1409 is executed.

In step S1409, the hold printing application 313 or the remote hold printing application 314 is activated as a result of the print application icon 401 or 402 being touched by the user.

In step S1410, the hold printing application 313 or the remote hold printing application 314 displays the document list screen 500 or 520.

In step S1411, the processing advances to step S1412 if the hold printing application 313 has been activated, or the processing advances to step S1413 if the remote hold printing application 314 has been activated.

In step S1412, the hold printing application 313 acquires bibliographic information stored under the user name “Sato”, which is the head node.

In step S1413, the remote hold printing application 314 acquires bibliographic information stored under the user name “Sato”, which is the head node, and bibliographic information stored under the user name “Sato-remote”, which is the head node.

In step S1414, the hold printing application 313 or the remote hold printing application 314 displays a list (document list) of print data that can be printing targets and deletion targets in the operation unit 206, based on the acquired bibliographic information, and then ends a series of processes

According to the present embodiment described above, when the user logs in, bibliographic information regarding print jobs of the user is acquired from the bibliography server, and therefore, when the remote hold printing application is executed, a list of bibliographic information regarding print jobs that can be printing targets can be displayed without delay.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-037775, filed Mar. 1, 2019, which is hereby incorporated by reference herein in its entirety.

What is claimed is:

1. An image forming system comprising a document receiving apparatus, an output apparatus, and a bibliography server,
the document receiving apparatus comprising:
a first memory storing first instructions; and
a first processor which is capable of executing the first instructions causing the document receiving apparatus to accept and store print jobs,
the bibliography server comprising:
a second memory storing second instructions; and
a second processor which is capable of executing the second instructions causing the bibliography server to receive bibliographic information that includes a storage location of each print job from the document receiving apparatus and store the bibliographic information, and
the output apparatus comprising:
a third memory storing third instructions; and
a third processor which is capable of executing the third instructions causing the output apparatus to:
acquire the bibliographic information from the bibliography server;
in response to an instruction for remote hold printing, display the bibliographic information as a list of print jobs that are output targets; and
acquire a print job selected from the list, from the storage location and execute the print job.

2. The image forming system according to claim 1,
wherein, in response to the instruction for remote hold printing that is given by a user, the output apparatus acquires the bibliographic information regarding a print job of the user from the bibliography server.

3. The image forming system according to claim 1,
wherein, in response to a user logging in to the output apparatus, the output apparatus acquires the bibliographic information regarding a print job of the user from the bibliography server.

4. The image forming system according to claim 1,
wherein the output apparatus also functions as a document receiving apparatus, and acquires, from the bibliography server, the bibliographic information regarding a print job that is stored in a document receiving apparatus that is not the output apparatus.

5. The image forming system according to claim 4,
wherein, in response to an instruction for remote hold printing, the output apparatus displays the bibliographic information acquired from the bibliography server and bibliographic information regarding a print job that is stored in the output apparatus.

6. The image forming system according to claim 1,
wherein each of the document receiving apparatus, the output apparatus, and the bibliography server is an image forming apparatus.

7. An image forming apparatus configured to function as an output apparatus that is connected to a document receiving apparatus that accepts and stores print jobs and a bibliography server that receives bibliographic information including a storage location of each print job from the document receiving apparatus and stores the bibliographic information, the image forming apparatus comprising:
a memory storing instructions; and
a processor which is capable of executing the instructions causing the image forming apparatus to:
acquire the bibliographic information from the bibliography server;
display, in response to an instruction for remote hold printing, the acquired bibliographic information as a list of print jobs that are output targets; and
acquire, in response to an instruction, a print job selected from the list, from the storage location and execute the print job.

8. The image forming apparatus according to claim 7,
wherein, in response to the instruction for remote hold printing that is given by a user, the bibliographic information regarding a print job of the user is acquired from the bibliography server.

9. The image forming apparatus according to claim 7,
wherein, in response to a user logging in to the image forming apparatus, the bibliographic information regarding a print job of the user is acquired from the bibliography server.

10. The image forming apparatus according to claim 7,
wherein the image forming apparatus also functions as a document receiving apparatus, and
the bibliographic information regarding a print job that is stored in a document receiving apparatus that is not the output apparatus is acquired from the bibliography server.

11. The image forming apparatus according to claim 10,
wherein, in response to an instruction for remote hold printing, the bibliographic information acquired from the bibliography server and bibliographic information regarding a print job that is stored in the output apparatus are displayed.

12. An output method that is performed in an image forming system that includes a document receiving apparatus, an output apparatus, and a bibliography server, the method comprising:
accepting and storing print jobs using the document receiving apparatus;
receiving bibliographic information that includes a storage location of each print job from the document receiving apparatus and storing the bibliographic information using the bibliography server;
acquiring the bibliographic information from the bibliography server using the output apparatus;
in response to an instruction for remote hold printing, displaying the bibliographic information as a list of print jobs that are output targets using the output apparatus; and
acquiring a print job selected from the list, from the storage location and executing the print job using the output apparatus.

13. An output method that is performed by an image forming apparatus configured to function as an output apparatus that is connected to a document receiving apparatus that accepts and stores print jobs and a bibliography server that receives bibliographic information including a storage location of each print job from the document receiving apparatus and stores the bibliographic information, the method comprising:
acquiring the bibliographic information from the bibliography server; in response to an instruction for remote hold printing, displaying the acquired bibliographic information as a list of print jobs that are output targets; and
in response to an instruction, acquiring a print job selected from the list, from the storage location and executing the print job.

14. A non-transitory computer readable storage medium on which is stored a computer program for making a computer execute a control method for an image forming apparatus configured to function as an output apparatus that is connected to a document receiving apparatus that accepts and stores print jobs and a bibliography server that receives bibliographic information including a storage location of each print job from the document receiving apparatus and stores the bibliographic information, the method comprising:
acquiring the bibliographic information from the bibliography server;
in response to an instruction for remote hold printing, displaying the acquired bibliographic information as a list of print jobs that are output targets; and
in response to an instruction, acquiring a print job selected from the list, from the storage location and executing the print job.
